(19) United States
(12) Patent Application Publication
(10) Pub. No.: US 2024/0219766 A1
(43) Pub. Date: Jul. 4, 2024

(54) DISPLAY DEVICE AND METHOD FOR MANUFACTURING DISPLAY DEVICE

(71) Applicant: Japan Display Inc., Tokyo (JP)

(72) Inventors: Yoshikatsu IMAZEKI, Tokyo (JP); Yoichi KAMIJO, Tokyo (JP); Koichi MIYASAKA, Tokyo (JP); Shuichi OSAWA, Tokyo (JP); Yoshifumi KAMEI, Tokyo (JP)

(21) Appl. No.: 18/396,396

(22) Filed: Dec. 26, 2023

(30) Foreign Application Priority Data
Dec. 28, 2022 (JP) 2022-211625

(51) Int. Cl. G02F 1/1335

(52) U.S. Cl. CPC G02F 1/133514; G02F 2202/28

(57) ABSTRACT

A display device includes a display panel that has a display surface having a display region where an image is displayed and an opposite surface on an opposite side of the display surface, a color separation element placed on the opposite surface side of the display panel, the color separation element configured to disperse light from a light source and to emit, to the display panel, a plurality of rays of separated light with wavelengths different from each other, and an adhesive portion that bonds the display panel to the color separation element. The adhesive portion overlaps a periphery of the display panel in plan view.

### CROSS-REFERENCE TO RELATED APPLICATION

This application claims the benefit of priority from Japanese Patent Application No. 2022-211625 filed on Dec. 28, 2022, the entire contents of which are incorporated herein by reference.

### BACKGROUND

### 1. Technical Field

The present disclosure relates to a display device and a method for manufacturing the display device.

### 2. Description of the Related Art

The display device in Japanese Patent Application Laid-open Publication No. H10-319217 (JP-A-H10-319217) includes a liquid crystal display panel having pixels, a color separation element, and a surface light source device that emits light to the color separation element. The color separation element separates light from the surface light source device into beams of light in colors different from each other and focuses the beams of light on the pixels of the liquid crystal display panel.

In the display device of JP-A-H10-319217, the liquid crystal display panel (display panel) and the color separation element are bonded with, for example, an adhesive. The liquid crystal display panel (display panel) and the color separation element are bonded with a given distance therebetween and the given distance is desirably maintained so that the light from the color separation element is focused on the pixels. In other words, it is desired that the display panel and the color separation element be securely bonded with an adhesive.

It is an object of the present disclosure to provide a display device and a method for manufacturing the display device that can securely bond a display panel and a color separation element with an adhesive.

### SUMMARY

A display device according to the present disclosure includes a display panel that has a display surface having a display region where an image is displayed and an opposite surface on an opposite side of the display surface, a color separation element placed on the opposite surface side of the display panel, the color separation element configured to disperse light from a light source and to emit, to the display panel, a plurality of rays of separated light with wavelengths different from each other, and an adhesive portion that bonds the display panel to the color separation element. The adhesive portion overlaps a periphery of the display panel in plan view.

A method for manufacturing a display device is disclosed. The method includes applying an adhesive to a board surface of a color separation element configured to disperse light from a light source and to emit a plurality of rays of separated light with wavelengths different from each other, and sticking the color separation element and the display panel together with a periphery of the display panel overlapping the adhesive in plan view.

### BRIEF DESCRIPTION OF THE DRAWINGS

FIG. 1 is a plan view of a display device according to an embodiment of the present disclosure;

FIG. 2 is a sectional view of the display device;

FIG. 3 is a view illustrating a circuit configuration of a display panel;

FIG. 4 is a sectional view of the display panel;

FIG. 5 is a sectional view of a color separation element;

FIG. 6 is an enlarged sectional view of the color separation element;

FIG. 7 is a perspective view illustrating the color separation element to which an adhesive has been applied;

FIG. 8 is a perspective view illustrating the color separation element and the display panel being stuck together at a sticking step; and

FIG. 9 is a plan view of a display device according to a modification of the embodiment of the present disclosure.

### DETAILED DESCRIPTION

Embodiments of the present disclosure will be described below with reference to the drawings. The present disclosure is not limited by what is described in the following embodiments. Components described below include those that can be easily assumed by a person skilled in the art and those that are substantially the same. Furthermore, the components described below can be combined as appropriate.

What is disclosed herein is merely an example, and any appropriate modification that would be easily conceived of by a person skilled in the art, while maintaining the purport of the present disclosure, is naturally included in the scope of the present disclosure. The drawings may schematically illustrate the width, thickness, shape, and the like of each part compared to the actual mode for the sake of clarity of explanation, but this is merely an example and does not limit the interpretation of the present disclosure. In the present specification and the drawings, elements similar to those described previously with respect to the drawings already mentioned are given the same reference signs and the detailed description thereof may be omitted as appropriate.

The X and Y directions illustrated in the drawings are orthogonal to each other and parallel to a main surface of a substrate included in a display device 1. The +X and −X sides in the X direction and the +Y and −Y sides in the Y direction correspond to the sides of the display device 1. The Z direction is orthogonal to the X and Y directions and corresponds to the thickness direction of the display device 1. The +Z side in the Z direction corresponds to the front surface side where an image is displayed in the display device 1, and the −Z side in the Z direction corresponds to the rear surface side of the display device 1. The X, Y, and Z directions are examples, and the present disclosure is not limited to these directions.

In the present specification, “plan view” refers to viewing the display device 1 from the +Z side to the −Z side along the Z direction. “Side view” refers to viewing the display device 1 along a direction orthogonal to the Z direction (that is, direction parallel to the X and Y directions).

### Display Device 1

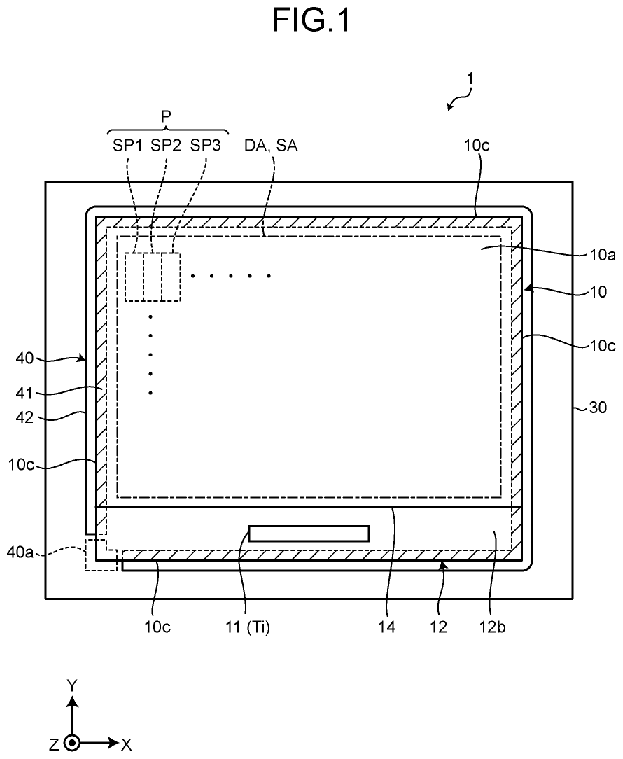

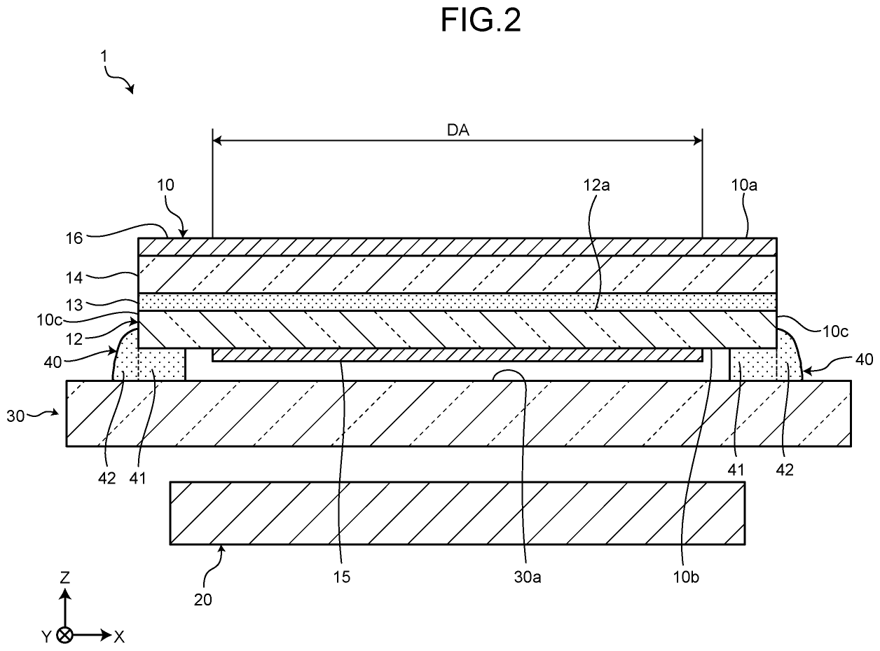

FIG. 1 is a plan view of the display device 1 according to an embodiment of the present disclosure. FIG. 2 is a sectional view of the display device 1. The display device 1 displays images on the basis of image signals output from an external device (not illustrated) that is electrically coupled through a flexible wiring board (not illustrated).

The display device 1 is applied, for example, to a head-up display. The head-up display projects an image onto a translucent object, such as a vehicle windshield, to allow a user to see a virtual image. The display device 1 includes a display panel 10, a light source device 20, a color separation element 30, and an adhesive portion 40. The light source device 20, the color separation element 30, and the display panel 10 are aligned in this order along the Z direction from the −Z side to the +Z side.

The display panel 10 is a transmissive liquid crystal display. The display panel 10 may be, for example, an organic electroluminescent (EL) display and an inorganic EL display. As illustrated in FIGS. 1 and 2, the display panel 10 has a display surface 10a having a display region DA where images are displayed and an opposite surface 10b on the opposite side of the display surface 10a. The display surface 10a corresponds to the front surface of the display panel 10. The opposite surface 10b corresponds to the rear surface of the display panel 10. As illustrated in FIG. 1, the display panel 10 includes a plurality of pixels P aligned in a matrix (row-column configuration) along the X and Y directions in the display region DA.

The pixels P each have a first sub-pixel SP1, a second sub-pixel SP2, and a third sub-pixel SP3. The first sub-pixel SP1 is a red sub-pixel. The second sub-pixel SP2 is a green sub-pixel. The third sub-pixel SP3 is a blue sub-pixel. The first sub-pixel SP1, the second sub-pixel SP2 and the third sub-pixel SP3 are aligned in this order along the X direction. The array of the first sub-pixel SP1, the second sub-pixel SP2 and the third sub-pixel SP3 is what is called a stripe array. Hereinafter, when the first sub-pixel SP1, the second sub-pixel SP2, and the third sub-pixel SP3 are described without distinction, they may simply be described as a “sub-pixel SP”. Not to mention, the array of sub-pixels SP is not limited to a stripe array, and the colors of sub-pixels SP are not limited to the aforementioned colors.

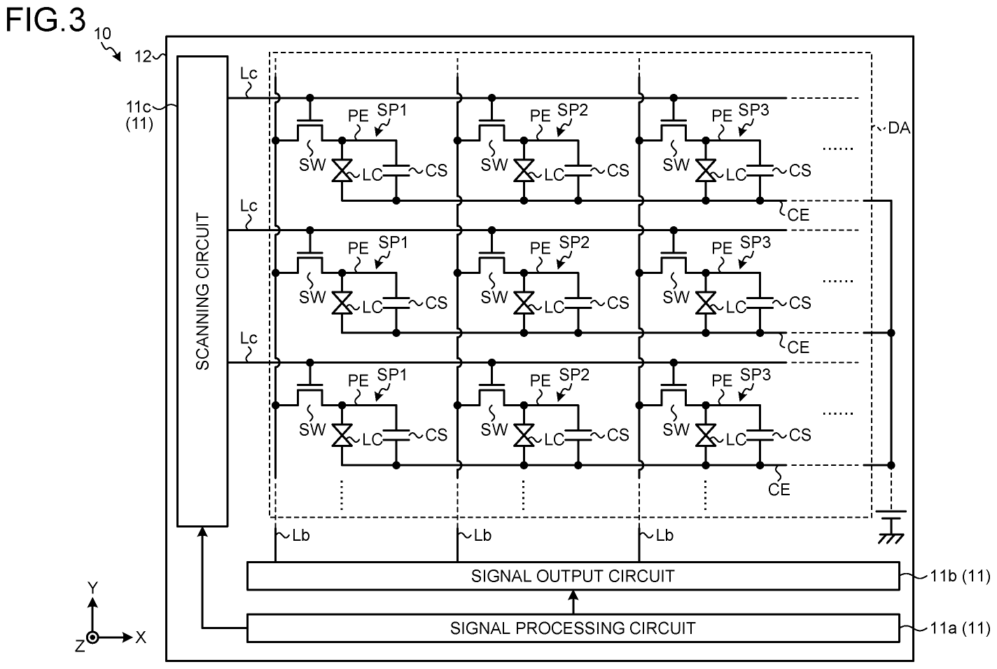

FIG. 3 is a view illustrating a circuit configuration of the display panel 10. The display panel 10 includes a drive circuit 11, as well as a switching element SW, a sub-pixel electrode PE, a common electrode CE, a liquid crystal capacitance LC, and a holding capacitance CS that are included in each of a plurality of the sub-pixels SP.

The drive circuit 11 drives the display panel 10. The drive circuit 11 includes a signal processing circuit 11a, a signal output circuit 11b, and a scanning circuit 11c.

The signal processing circuit 11a outputs sub-pixel signals indicating gradations of the sub-pixels SP to the signal output circuit 11b on the basis of image signals transmitted from the external device. The signal processing circuit 11a outputs clock signals to the signal output circuit 11b and the scanning circuit 11c to synchronize the operation of the signal output circuit 11b with that of the scanning circuit 11c.

The signal output circuit 11b outputs the sub-pixel signals to the sub-pixels SP. The signal output circuit 11b and the sub-pixels SP are electrically coupled through a plurality of signal lines Lb extending along the Y direction.

The scanning circuit 11c scans the sub-pixels SP in synchronization with the output of the sub-pixel signals by the signal output circuit 11b. The scanning circuit 11c and the sub-pixels SP are electrically coupled through a plurality of scanning lines Lc extending along the X direction.

The region demarcated by two signal lines Lb adjacent to each other in the X direction and two scanning lines Lc adjacent to each other in the Y direction in plan view corresponds to the sub-pixel SP.

The switching element SW includes a thin-film transistor (TFT), for example. In the switching element SW, a source electrode is electrically coupled to the signal line Lb, and a gate electrode is electrically coupled to the scanning line Lc.

The sub-pixel electrode PE is coupled to a drain electrode of the switching element SW. A plurality of the common electrodes CE are arranged corresponding to the scanning lines Lc. The sub-pixel electrode PE and the common electrode CE are translucent.

The liquid crystal capacitance LC is a capacitive component of a liquid crystal material in a liquid crystal layer 13, which will be described below, between the sub-pixel electrode PE and the common electrode CE. The holding capacitance CS is placed between an electrode with the same potential as the common electrode CE and an electrode with the same potential as the sub-pixel electrode PE.

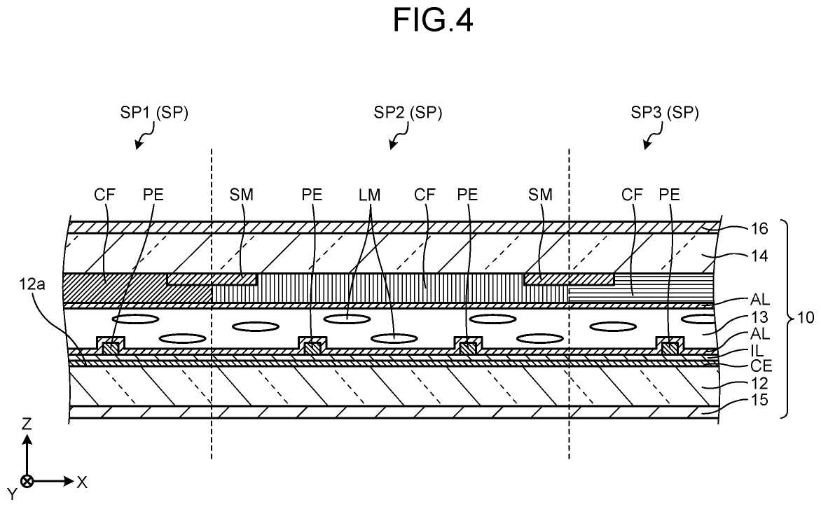

FIG. 4 is a sectional view of the display panel 10. The sub-pixel SP further includes a first substrate 12, the liquid crystal layer 13, and a second substrate 14. The first substrate 12, the liquid crystal layer 13, and the second substrate 14 are all translucent and are aligned in this order along the Z direction from the −Z side to the +Z side. The first substrate 12 and the second substrate 14 are rectangular in plan view.

The common electrode CE is placed on a main surface 12a on the +Z-side of the first substrate 12. An insulating layer IL is placed on the front surface of the common electrode CE, and the sub-pixel electrode PE and an orientation film AL are further placed.

The sub-pixel electrode PE is placed between the insulating layer IL and the orientation film AL. In this manner, the common electrode CE is placed on, and the sub-pixel electrode PE is placed above the first substrate 12. In other words, the display panel 10 is a horizontal electric field type liquid crystal display.

The second substrate 14 is located on the front surface side of the first substrate 12. A color filter CF and a light-shielding film SM are placed on, and an orientation film AL is placed under the rear surface of the second substrate 14. The light-shielding film SM and the color filter CF are placed between the second substrate 14 and the orientation film AL.

The color filter CF is rectangular in plan view and one color filter CF is placed for one sub-pixel SP. The color filter CF is translucent, and the peak of the spectrum of light to be transmitted is predetermined. The peak of the spectrum corresponds to the color of the color filter CF. The color of the color filter CF is the same as that of the sub-pixel SP. In other words, the red first sub-pixel SP1 has a red color filter CF, the green second sub-pixel SP2 has a green color filter CF, and the blue third sub-pixel SP3 has a blue color filter CF.

The light-shielding film SM is lightproof and overlaps in plan view the boundaries of the sub-pixels SP that are adjacent to each other in the X and Y directions. That is, the light-shielding film SM overlaps in plan view the signal line Lb and the scanning line Lc. In FIG. 4, the signal line Lb and the scanning line Lc are omitted. The signal lines Lb and the scanning lines Lc are placed on the main surface 12a of the first substrate 12.

The liquid crystal layer 13 includes a plurality of liquid crystal molecules LM. The liquid crystal layer 13 is present between the first substrate 12 and the second substrate 14 and overlaps the display region DA in plan view. Specifically, the liquid crystal layer 13 is present between two orientation films AL facing each other. The orientation of the liquid crystal molecules LM is regulated by the two orientation films AL facing each other.

As illustrated in FIGS. 2 and 4, the display panel 10 further includes a first polarizing plate 15 placed on the rear surface of the first substrate 12 and a second polarizing plate 16 placed on the front surface of the second substrate 14.

The first polarizing plate 15 has a transmission axis orthogonal to the Z direction. The second polarizing plate 16 has a transmission axis orthogonal to the transmission axis of the first polarizing plate 15 and the Z direction.

As illustrated in FIG. 1, the first substrate 12 has an exposed portion 12b that is exposed from the second substrate 14 in plan view. The exposed portion 12b is on the −Y side of the second substrate 14 in plan view. An IC chip Ti including the drive circuit 11 is placed on the front surface of the exposed portion 12b. The front surface of the exposed portion 12b is part of the main surface 12a of the first substrate 12.

The drive circuit 11 outputs sub-pixel signals to the sub-pixels SP on the basis of image signals, thereby generating an electric field in the liquid crystal layer 13 and changing the orientation of the liquid crystal molecules LM. Thus, the light transmitted through the display panel 10 is modulated, to display an image.

As illustrated in FIG. 2, the light source device 20 is placed on the rear surface side of the display panel 10. The light source device 20 emits light (hereinafter described as emitted light) toward the display panel 10. The light source device 20 is, for example, a direct-lit backlight and has a plurality of light-emitting diodes (not illustrated).

As illustrated in FIGS. 1 and 2, the color separation element 30 is a rectangular plate in plan view. The color separation element 30 is larger than the display panel 10 in plan view. Specifically, the periphery of the color separation element 30 is located outside the periphery of the display panel 10 in plan view. Part of the color separation element 30 may be located outside of the display panel 10 in plan view.

As illustrated in FIG. 2, the color separation element 30 is placed on the opposite surface 10b side of the display panel 10. Specifically, the color separation element 30 is placed between the display panel 10 and the light source device 20. The color separation element 30 is translucent, and the emitted light from the light source device 20 enters the display panel 10 through the color separation element 30.

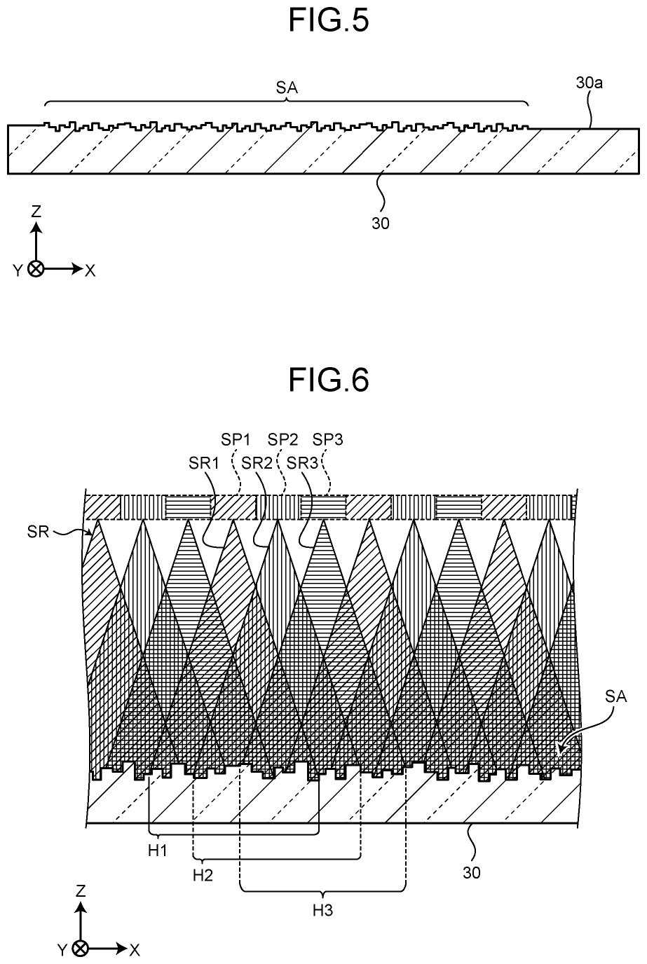

FIG. 5 is a sectional view of the color separation element 30. FIG. 6 is an enlarged sectional view of the color separation element 30. The color separation element 30 disperses the emitted light from the light source device 20 and emits, to the pixel P of the display panel 10, a plurality of rays of separated light SR with wavelengths different from each other. The color separation element 30 has a separation region SA that emits the separated light SR. The separation region SA is on the board surface of the color separation element 30 (front surface of the color separation element 30; hereinafter may be described as an emitting surface 30a) facing the display panel 10 and overlaps the display region DA in plan view.

As illustrated in FIG. 6, the separated light SR emitted from the separation region SA includes first separated light SR1 in red, the same color as the color of the first sub-pixel SP1, second separated light SR2 in green, the same color as the second sub-pixel SP2, and third separated light SR3 in blue, the same color as the third sub-pixel SP3. In the separation region SA, the front surface of the color separation element 30 has a given uneven shape.

The given uneven shape is such that the first separated light SR1 gathers in the first sub-pixel SP1 from a first range H1, which is larger than the first sub-pixel SP1 in plan view and overlaps the first sub-pixel SP1 in plan view. The given uneven shape is such that the second separated light SR2 gathers in the second sub-pixel SP2 from a second range H2, which is larger than the second sub-pixel SP2 in plan view and overlaps the second sub-pixel SP2 in plan view. Furthermore, the given uneven shape is such that the third separated light SR3 gathers in the third sub-pixel SP3 from a third range H3, which is larger than the third sub-pixel SP3 in plan view and overlaps the third sub-pixel SP3 in plan view.

There are a plurality of the first ranges H1 corresponding to the first sub-pixels SP1. There are a plurality of the second ranges H2 corresponding to the second sub-pixels SP2. There are a plurality of the third ranges H3 corresponding to the third sub-pixels SP3. The first range H1, the second range H2, and the third range H3 have portions overlapping each other in plan view.

In this manner, the color separation element 30 separates the emitted light from the light source device 20 for each wavelength corresponding to the color of the individual color filter CF, and causes the light (separated light SR) with the wavelength corresponding to the color filter CF to enter and be transmitted through the color filter CF. Thus, the loss of quantity of the emitted light from the light source device 20 can be suppressed and the utilization efficiency of the emitted light can be increased compared to a case in which the display device 1 does not include the color separation element 30 and the emitted light from the light source device 20 directly enters the display panel 10.

As illustrated in FIGS. 1 and 2, the adhesive portion 40 bonds the display panel 10 to the color separation element 30. Specifically, the adhesive portion 40 bonds the peripheral portion of the display panel 10 to the emitting surface 30a of the color separation element 30.

As illustrated in FIG. 1, the adhesive portion 40 is around the display region DA and the separation region SA in plan view. In other words, the adhesive portion 40 is outside of the display region DA and the separation region SA in plan view. The adhesive portion 40 is around the first polarizing plate 15 in plan view (outside of the first polarizing plate 15 in plan view) (see FIG. 2).

The adhesive portion 40 overlaps the periphery of the display panel 10 in plan view. Specifically, the adhesive portion 40 is placed along the periphery of the display panel 10 in plan view. The adhesive portion 40 has an overlapping portion 41 and a protruding portion 42 in one piece.

The overlapping portion 41 is a section of the adhesive portion 40 illustrated by hatching in FIG. 1, and overlaps both the display panel 10 and the color separation element 30 in plan view.

As illustrated in FIG. 2, the overlapping portion 41 is between the display panel 10 and the color separation element 30 in the Z direction, is in contact with the peripheral portion of the opposite surface 10b of the display panel 10 and the emitting surface 30a of the color separation element 30, and bonds the peripheral portion of the opposite surface 10b of the display panel 10 to the emitting surface 30a of the color separation element 30.

As illustrated in FIG. 1, the protruding portion 42 protrudes from the periphery of the display panel 10 to the side of the display panel 10 in plan view. As illustrated in FIG. 2, the protruding portion 42 is in contact with a side surface 10c of the display panel 10 and the emitting surface 30a of the color separation element 30, and bonds the side surface 10c of the display panel 10 (specifically, the section on the −Z side of the side surface 10c of the display panel 10) to the emitting surface 30a of the color separation element 30. In this manner, the protruding portion 42, which is part of the adhesive portion 40, overlaps the side surface 10c of the display panel 10 in side view.

The adhesive portion 40 is in continuous contact at the peripheral portion of the display panel 10 from the peripheral portion of the opposite surface 10b to the section on the −Z side of the side surface 10c, and is in contact with the periphery of the opposite surface 10b. In the present embodiment, the side surface 10c of the display panel 10 corresponds to the side surface of the first substrate 12.

In this manner, the adhesive portion 40 is in contact with the emitting surface 30a of the color separation element 30, the opposite surface 10b and the side surface 10c of the display panel 10, and bonds the emitting surface 30a of the color separation element 30 to the opposite surface 10b and the side surface 10c of the display panel 10.

The adhesive portion 40 has a discontinuous portion 40a. The discontinuous portion 40a is a gap formed by the discontinuity of a basic material of the adhesive portion 40. The discontinuous portion 40a causes the space inside of the adhesive portion 40 to communicate with the space outside of the adhesive portion 40 between the display panel 10 and the color separation element 30. Thus, condensation forming in the space inside the adhesive portion 40 between the display panel 10 and the color separation element 30 can be suppressed.

In the present embodiment, there is one discontinuous portion 40a at a position on the −X and −Y side of the adhesive portion 40. Not to mention, the position of the discontinuous portion 40a is not limited to the position on the −X and −Y side of the adhesive portion 40, and the number of the discontinuous portions 40a is not limited to one.

The adhesive portion 40 is formed by an adhesive, which will be described below, curing. The adhesive is a one-part adhesive and, for example, an ultraviolet (UV) curable adhesive. The adhesive may be a two-part adhesive or a thermosetting adhesive.

The display panel 10 and the color separation element 30 are bonded with the distance in the Z direction between the display panel 10 and the color separation element 30 being a given distance. With the given distance, the separated light SR gathers in the sub-pixel SP.

As described above, the adhesive portion 40 bonds the emitting surface 30a of the color separation element 30 to the opposite surface 10b and the side surface 10c of the display panel 10, thereby increasing the contact area between the color separation element 30 and the display panel 10 and the adhesive portion 40. Therefore, the display panel 10 and the color separation element 30 can be securely bonded with the adhesive.

### Method for Manufacturing Display Device 1

A bonding process for bonding the display panel 10 to the color separation element 30 in a method for manufacturing the display device 1 will be described next.

The bonding process includes an application step of applying an adhesive to the color separation element 30, a sticking step of sticking the color separation element 30 and the display panel 10 together, and a curing step of curing the adhesive. The application step, the sticking step, and the curing step are performed in this order.

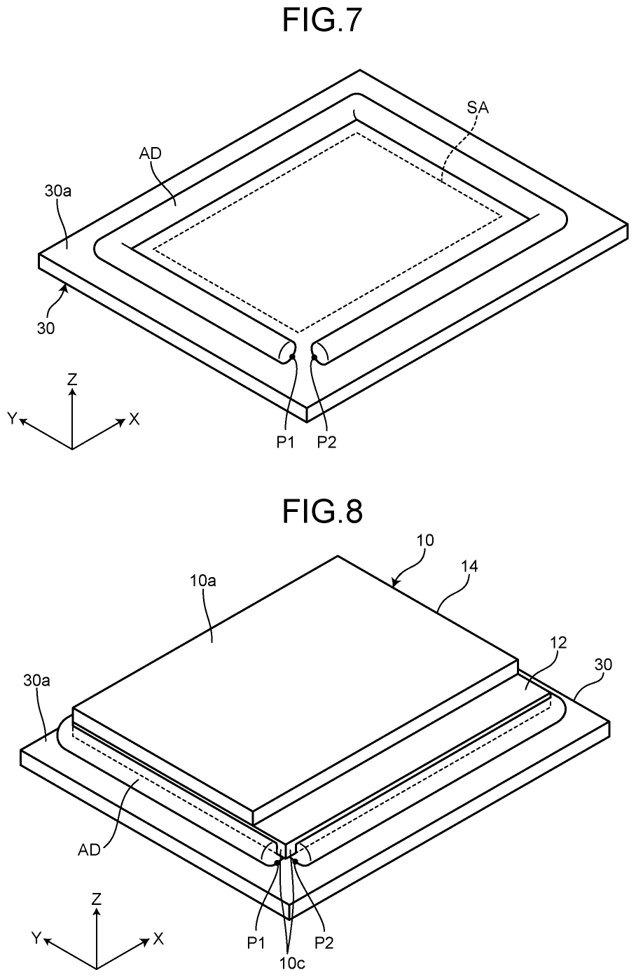

FIG. 7 is a perspective view illustrating the color separation element 30 to which an adhesive AD has been applied. At the application step, the adhesive AD is applied to the board surface (emitting surface 30a) of the color separation element 30. Specifically, the adhesive AD is applied around the separation region SA on the emitting surface 30a. The adhesive AD is applied at a position overlapping the periphery of the display panel 10 in plan view. The adhesive AD is applied using a dispenser.

A start position P1, where the application of the adhesive AD starts, and an end position P2, where the application of the adhesive AD ends, are different from each other in plan view. With this configuration, the discontinuous portion 40a in the adhesive portion 40 is formed when the adhesive AD cures.

As described above, the adhesive AD is a one-part adhesive and has no mixture. Thus, there is no mixing step of mixing a mixture into the adhesive AD in the manufacture of the display device 1. Consequently, the adhesive AD does not have voids created by air mixed in at the mixing step, and the adhesive AD is applied to the color separation element 30 while splitting of the adhesive AD resulting from the voids is suppressed.

FIG. 8 is a perspective view illustrating the color separation element 30 and the display panel 10 being stuck together at the sticking step. At the sticking step, the color separation element 30 and the display panel 10 are stuck together with the periphery of the display panel 10 overlapping the adhesive AD in plan view.

Specifically, at the sticking step, the emitting surface 30a of the color separation element 30 and the opposite surface 10b of the display panel 10 face each other, and the display panel 10 approaches the color separation element 30 with the periphery of the display panel 10 overlapping the adhesive AD in plan view, whereby the peripheral portion of the opposite surface 10b of the display panel 10 comes into contact with the adhesive AD.

Furthermore, when the display panel 10 approaches the color separation element 30 until the distance in the Z direction between the emitting surface 30a of the color separation element 30 and the opposite surface 10b of the display panel 10 becomes the aforementioned given distance, the adhesive AD is deformed and comes into contact with the side surface 10c of the display panel 10. Thus, the adhesive AD is in continuous contact at the peripheral portion of the display panel 10 from the peripheral portion of the opposite surface 10b to the section on the −Z side of the side surface 10c.

In this manner, at the sticking step, the distance in the Z direction between the emitting surface 30a of the color separation element 30 and the opposite surface 10b of the display panel 10 is adjusted to the aforementioned given distance, and the peripheral portion of the display panel 10 and the emitting surface 30a of the color separation element 30 are bonded together with the adhesive AD therebetween.

When the color separation element 30 and the display panel 10 are stuck together, air that is inside of the adhesive AD in plan view between the color separation element 30 and the display panel 10 leaks outward from the adhesive AD between the start position P1 and the end position P2 of the adhesive AD illustrated in FIGS. 7 and 8. Thus, deformation of the color separation element 30 and the display panel 10 due to the force created by air compression between the color separation element 30 and the display panel 10 can be prevented.

Next, the adhesive AD is cured at the curing step. As described above, the adhesive AD is a UV curable adhesive, and when the adhesive AD is irradiated with UV light, the adhesive AD cures. As the adhesive AD cures, the adhesive portion 40 having the discontinuous portion 40a is formed. The liquid crystal layer 13, the first polarizing plate 15, and the second polarizing plate 16 are omitted in FIG. 8.

Although preferred embodiments of the present disclosure have been described above, the present disclosure is not limited to such embodiments. What is disclosed in the embodiments is merely an example, and various modifications can be made without departing from the intent of the present disclosure. Any appropriate modification made to the extent not departing from the intent of the present disclosure naturally belongs to the technical scope of the present disclosure.

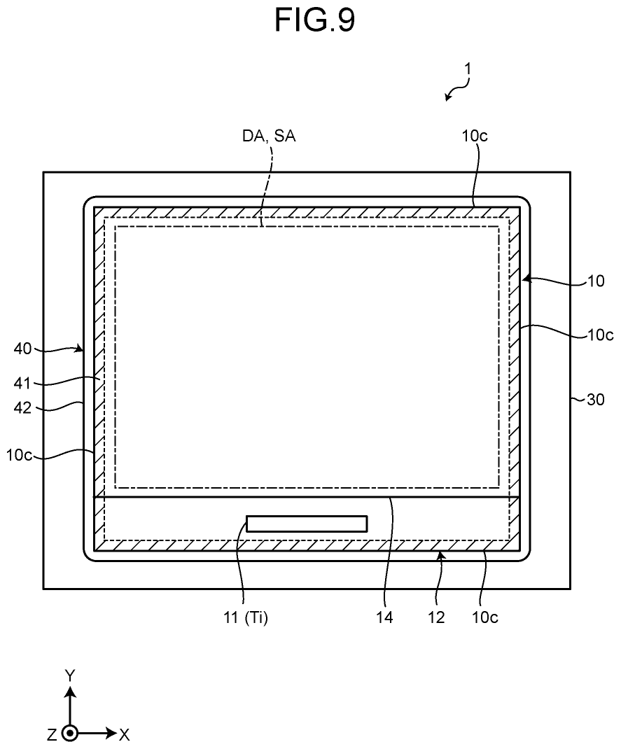

FIG. 9 is a plan view of the display device 1 according to a modification of the embodiment of the present disclosure. As illustrated in FIG. 9, the adhesive portion 40 is placed around the entire perimeter of the display panel 10 in plan view, without the discontinuous portion 40a. In this case, foreign matter's mixing inside the adhesive AD in plan view between the color separation element 30 and the display panel 10 is suppressed. In this case, as in the aforementioned embodiment, the discontinuous portion 40a of the adhesive portion 40 is formed in the manufacturing process of the display device 1, and then the discontinuous portion 40a is filled with the adhesive AD. The adhesive portion 40 may be placed around the entire perimeter of the display panel 10 by subsequently curing the adhesive AD filled in the discontinuous portion 40a. At the aforementioned application or sticking step, the gap of the adhesive AD between the start position P1 and the end position P2 may be further filled with the adhesive AD. At the aforementioned application step, the adhesive portion 40 may be placed around the entire perimeter of the display panel 10 by applying the adhesive AD is applied around the entire perimeter of the separation region SA.

It is understood that any other effects brought about by the modes described in the embodiments that are obvious from the description of the present specification or that would be conceived of by a person skilled in the art are naturally brought about by the present disclosure.

What is claimed is:

1. A display device comprising:
a display panel that has a display surface having a display region where an image is displayed and an opposite surface on an opposite side of the display surface;
a color separation element placed on the opposite surface side of the display panel, the color separation element configured to disperse light from a light source and to emit, to the display panel, a plurality of rays of separated light with wavelengths different from each other; and
an adhesive portion that bonds the display panel to the color separation element, wherein
the adhesive portion overlaps a periphery of the display panel in plan view.

2. The display device according to claim 1, wherein the adhesive portion overlaps a side surface of the display panel in side view.

3. The display device according to claim 1, wherein
the color separation element has an emitting surface that faces the opposite surface and that emits the separated light, and
the adhesive portion bonds the emitting surface of the color separation element to the opposite surface and the side surface of the display panel.

4. The display device according to claim 1, the adhesive portion is around the display region in plan view.

5. The display device according to claim 1, wherein the adhesive portion has a discontinuous portion where a basic material is discontinuous.

6. The display device according to claim 1, wherein a periphery of the color separation element is located outside the periphery of the display panel in plan view.

7. A method for manufacturing a display device, the method comprising:
applying an adhesive to a board surface of a color separation element configured to disperse light from a light source and to emit a plurality of rays of separated light with wavelengths different from each other; and
sticking the color separation element and the display panel together with a periphery of the display panel overlapping the adhesive in plan view.

8. A method for manufacturing a display device according to claim 7, wherein the adhesive comes into contact with a side surface of the display panel at the sticking.
